(19) United States
(12) Patent Application Publication
(10) Pub. No.: US 2016/0281681 A1
(43) Pub. Date: Sep. 29, 2016

(54) WIND TURBINE

(71) Applicant: Rodney Dean MACDONALD, Weyburn (CA)

(72) Inventor: Rodney Dean MACDONALD, Weyburn (CA)

(21) Appl. No.: 14/666,453

(22) Filed: Mar. 24, 2015

(51) Int. Cl. F03D 3/06; F03D 9/00; F03D 7/06; F03D 3/00

(52) U.S. Cl. CPC F03D 3/068; F03D 3/002; F03D 3/005; F03D 3/064; F03D 9/002; F03D 7/06

(57) ABSTRACT

A wind turbine includes an air-foil support structure. A first air-foil assembly is configured to be coupled to the air-foil support structure in such a way that the first air-foil assembly is pitched. A second air-foil assembly is configured to be coupled to the air-foil support structure. The second air-foil assembly is spaced apart from the first air-foil assembly in such a way that the second air-foil assembly is pitched.

### TECHNICAL FIELD

This document relates to (and is not limited to) the technical field of a wind turbine.

### BACKGROUND

A wind turbine is configured to convert kinetic energy from the wind into electrical power. The wind turbine may be used for charging batteries, and may be referred to as a wind charger. The wind turbine may be used for making contributions to a domestic power supply while selling unused power back to the utility supplier via the electrical grid. Arrays of large turbines, known as wind farms, are becoming an increasingly important source of renewable energy and are used by many countries as part of a strategy to reduce their reliance on fossil fuels.

### SUMMARY

It will be appreciated that there exists a need to mitigate (at least in part) at least one problem associated with existing wind turbines. After much study of the known systems and methods with experimentation, an understanding of the problem and its solution has been identified and is articulated as follows:

The disadvantage of the fixed wing wind turbines is that the power the wind turbine extracts in upwind positions is partially spent in downwind positions.

About 50% to about 70% of the energy extracted upwind is spent dragging the blades of the wind turbine through the downwind positions not leaving much excess energy for power generation. To rectify this, the variable pitch wind turbine was designed; however, with its blade positions, this wind turbine does reduce the drag of a normal fixed wing but it creates an elliptical orbit around the axis of the wind turbine because of the overhang caused by the front pivoting blades. Much like a propeller with one longer blade, it causes vibration and limited performance due to drag.

To mitigate, at least in part, at least one problem associated with existing wind turbines, there is provided (in accordance with a major aspect) a wind turbine. The wind turbine includes (and is not limited to) an elongated rotatable shaft assembly. An air-foil support structure is fixedly attached to the elongated rotatable shaft assembly. The air-foil support structure extends radially from the elongated rotatable shaft assembly. A first air-foil assembly is configured to be coupled to the air-foil support structure (this is done in such a way that the first air-foil assembly travels along a curved path once the elongated rotatable shaft assembly is rotated along the longitudinal axis and the first air-foil assembly is pitched). A second air-foil assembly is configured to be coupled to the air-foil support structure. The second air-foil assembly is spaced apart from the first air-foil assembly (this is done in such a way that the second air-foil assembly is pitched).

To mitigate, at least in part, at least one problem associated with existing wind turbines, there is provided (in accordance with a major aspect) a wind turbine. The wind turbine includes (and is not limited to) an elongated rotatable shaft assembly having a longitudinal axis extending therethrough. The elongated rotatable shaft assembly is configured to rotate along the longitudinal axis through a rotation direction. An air-foil support structure is fixedly attached to the elongated rotatable shaft assembly. The air-foil support structure extends radially from the elongated rotatable shaft assembly. A first air-foil assembly is configured to be coupled to the air-foil support structure (this is done in such a way that the first air-foil assembly is variably pitched relative to a tangential line extending tangentially from the curved path, and the amount of pitch of the first air-foil assembly depends on the position of the first air-foil assembly along the curved path). A second air-foil assembly is configured to be coupled to the air-foil support structure. The second air-foil assembly is spaced apart from the first air-foil assembly (this is in such a way that the second air-foil assembly is pitched relative to the tangential line).

To mitigate, at least in part, at least one problem associated with existing wind turbines, there is provided (in accordance with a major aspect) a wind turbine. The wind turbine includes (and is not limited to) an air-foil support structure configured to travel along a curved path. A first air-foil assembly is configured to be coupled to the air-foil support structure (this is in such a way that the first air-foil assembly is pitched). A second air-foil assembly is configured to be coupled to the air-foil support structure. The second air-foil assembly is spaced apart from the first air-foil assembly (this is done in such a way that the second air-foil assembly is pitched).

To mitigate, at least in part, at least one problem associated with existing wind turbines, there is provided (in accordance with a major aspect) a retrofit kit The retrofit kit is for a wind turbine that has an air-foil support structure configured to travel along a curved path. The wind turbine also has a second air-foil assembly configured to be coupled to the air-foil support structure (this is done in such a way that the second air-foil assembly is pitched). The retrofit kit includes a first air-foil assembly. The first air-foil assembly includes a mounting assembly. The mounting assembly is configured to couple the first air-foil assembly to the air-foil support structure (this is done in such a way that the first air-foil assembly is pitched once mounted just so to the air-foil support structure, and the first air-foil assembly is spaced apart from second air-foil assembly).

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 (SHEET 1 OF 13 SHEETS) depicts a schematic view of an embodiment of a wind turbine. FIG. 1 depicts a top view;

FIGS. 2A to 2E (SHEETS 2 to 5 of 13 SHEETS) depict schematic views of embodiments of a first air-foil assembly and of a second air-foil assembly of the wind turbine of FIG. 1;

FIGS. 3A to 3C (SHEETS 6 to 8 of 13 SHEETS) depict schematic views of embodiments of an elongated rotatable shaft assembly and of an air-foil support structure of the wind turbine of FIG. 1;

FIGS. 4A to 4F (SHEETS 9 to 12 of 13 SHEETS) depict schematic views of embodiments of an air-foil pitch control mechanism of the wind turbine of FIG. 1; and

FIG. 5 (SHEET 13 of 13 SHEETS) depicts a schematic view of an embodiment of the wind turbine of FIG. 1 (in operation).

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 wind turbine
102 elongated rotatable shaft assembly
103 electrical generator
104 longitudinal axis
105 bearing supports
106 rotation direction
108 air-foil support structure
110 curved path
112 first air-foil assembly
114 tangential line
116 second air-foil assembly
118 longitudinally-extending tubular frame
120 first hinge assembly
122 second hinge assembly
124 first pivoting range
126 second pivoting range
128 support arms
130 air-foil pitch control mechanism
132 cam bearing
133 cam bearing support
134 cam support
136 cam assembly
138 movable control arm
139 control direction
140 roller assembly
142 wind vane
144 bushing assembly
146 first servo assembly
148 second servo assembly
900 wind direction
902 first position
904 second position
906 third position
908 fourth position

### DETAILED DESCRIPTION OF THE EXEMPLARY EMBODIMENTS

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

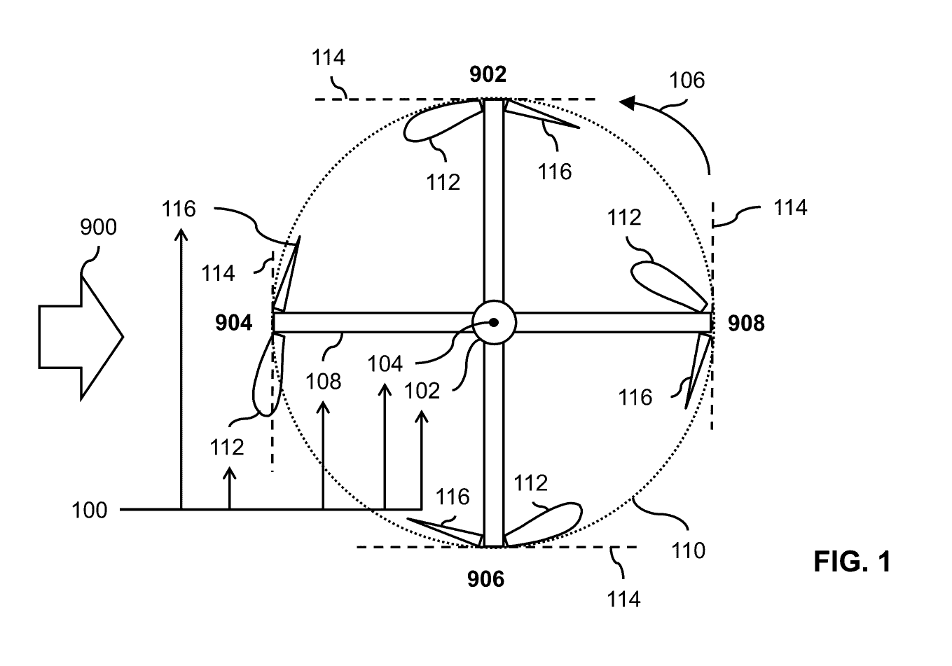

FIG. 1 depicts a schematic view of an embodiment of a wind turbine 100. FIG. 1 depicts a top view.

Referring (in general terms) to all of the FIGS., and more particularly to FIG. 1, there is depicted an embodiment of the wind turbine 100. The wind turbine 100 includes (and is not limited to) a combination of an elongated rotatable shaft assembly 102, an air-foil support structure 108, a first air-foil assembly 112, and a second air-foil assembly 116.

In accordance with a general embodiment, the air-foil support structure 108 is fixedly attached to the elongated rotatable shaft assembly 102. The air-foil support structure 108 extends radially from the elongated rotatable shaft assembly 102 (this is done in such a way that the air-foil support structure 108 travels along a curved path 110 once the elongated rotatable shaft assembly 102 is rotated). The first air-foil assembly 112 is configured to be coupled to the air-foil support structure 108 (this is done in such a way that the first air-foil assembly 112 travels along a curved path 110 once the elongated rotatable shaft assembly 102 is rotated along the longitudinal axis 104, and the first air-foil assembly 112 is pitched). The second air-foil assembly 116 is configured to be coupled to the air-foil support structure 108, and the second air-foil assembly 116 is spaced apart from the first air-foil assembly 112 (this is done in such a way that the second air-foil assembly 116 is pitched).

Pitch is defined as an angular orientation relative to a frame of reference, and/or to put, set, or plant an object in a fixed or definite place, position and/or spatial orientation relative to a frame of reference.

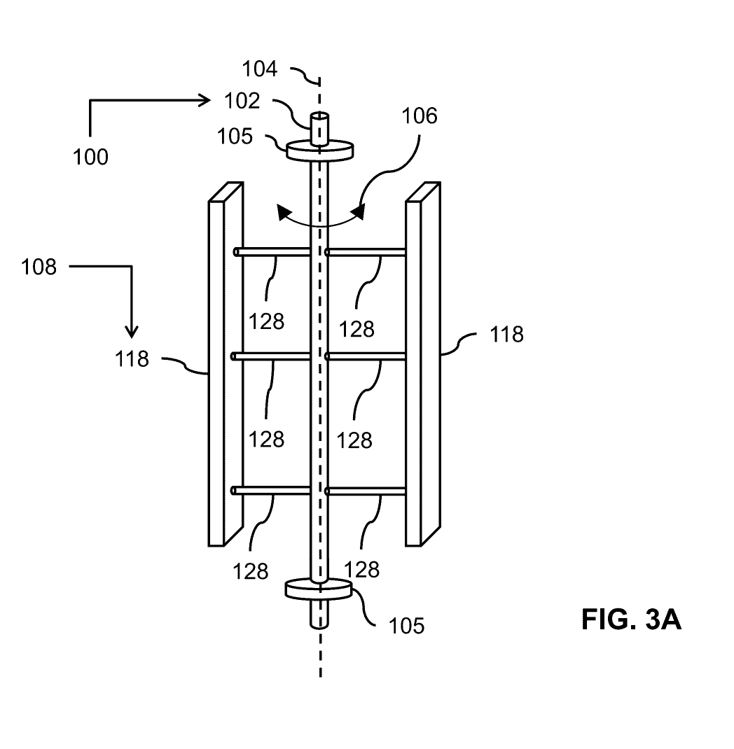

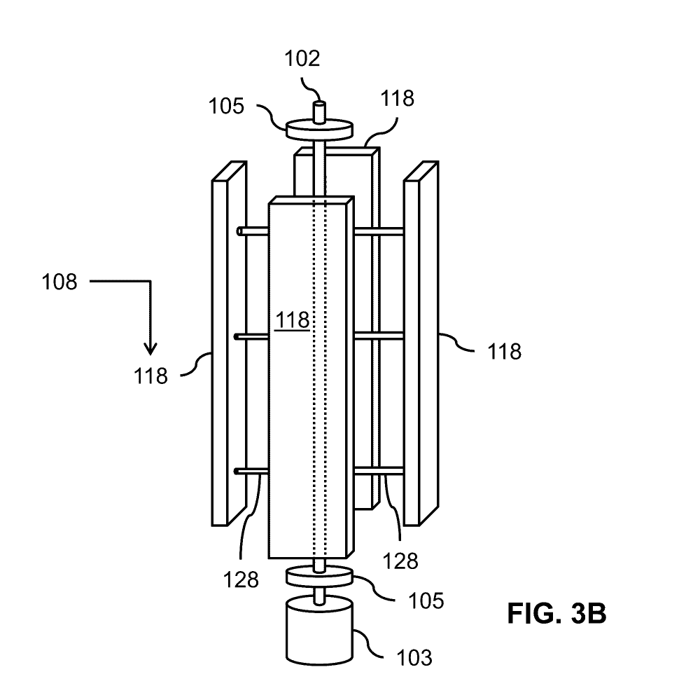

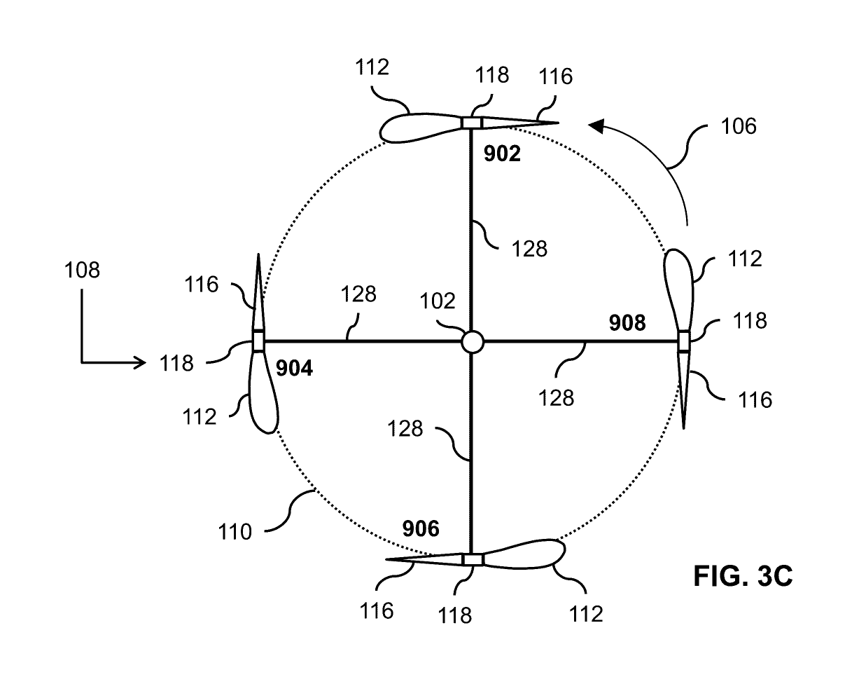

In accordance with a specific embodiment, the elongated rotatable shaft assembly 102 has a longitudinal axis 104 extending therethrough (that is, along a central elongated core portion of the elongated rotatable shaft assembly 102). The elongated rotatable shaft assembly 102 is configured to rotate along the longitudinal axis 104 through a rotation direction 106. The rotation direction 106 may be clockwise or counterclockwise (from the point of view of an end view of the elongated rotatable shaft assembly 102). More specifically, the elongated rotatable shaft assembly 102 is configured to be rotated clockwise or counterclockwise. The elongated rotatable shaft assembly 102 is configured to turn (rotate) an electrical generator 103. The electrical generator 103 is depicted in FIG. 3B. The elongated rotatable shaft assembly 102 is configured to be operatively coupled (either directly or indirectly) to a rotatable shaft of the electrical generator 103. Once the electrical generator 103 is coupled to the elongated rotatable shaft assembly 102, the electrical generator 103 is configured to generate electricity in response to rotation of the rotatable shaft (that is, by the rotation of the elongated rotatable shaft assembly 102). For instance, bearing supports 105 (depicted in FIG. 3A) are configured to support operative rotation of the elongated rotatable shaft assembly 102. The positional (spatial) alignment of the elongated rotatable shaft assembly 102 may be along a horizontal direction, a vertical direction, or any suitable positional alignment. The elongated rotatable shaft assembly 102 may be aligned either vertically, horizontally or in any suitable direction relative to the working surface or the ground.

It will be appreciated that the electrical generator 103 may be substituted for a water pump, winch cables, an elongated rotatable shaft assembly 102 can be turned for the purpose of providing mechanical power to non-electrical assemblies (such as, a water pump system, etc.).

The air-foil support structure 108 is coupled to (more specifically, is fixedly attached to) the elongated rotatable shaft assembly 102. The air-foil support structure 108 extends radially from the elongated rotatable shaft assembly 102. This is done in such a way that the first air-foil assembly 112 travels along a curved path 110 once the elongated rotatable shaft assembly 102 is rotated along the longitudinal axis 104. The curved path 110 may include a circular path, an oval path, or an elliptical path, etc. Preferably, the curved path 110 includes a circular path as depicted in FIG. 1, for convenience and/or for other operational efficiency factors.

The first air-foil assembly 112 is configured to be coupled (directly or indirectly) to the air-foil support structure 108. The coupling of the first air-foil assembly 112 with the air-foil support structure 108 is done in such a way that the first air-foil assembly 112 is variably pitched relative to a tangential line 114 extending tangentially from the curved path 110, and the amount of pitch (angled orientation or spatial orientation) of the first air-foil assembly 112 relative to the tangential line 114 depends on the position of the first air-foil assembly 112 along the curved path 110 (as the air-foil support structure 108 is rotated by the elongated rotatable shaft assembly 102). The first air-foil assembly 112 may include, for instance, a plank, a wing-shaped assembly, (any other suitable shape and/or configuration), etc. The first air-foil assembly 112 may be called a leading air-foil assembly (that is, the first air-foil assembly 112 leads into the rotation direction 106). The first air-foil assembly 112 travels along the rotation direction 106.

The second air-foil assembly 116 is configured to be coupled (directly or indirectly) to the air-foil support structure 108. The second air-foil assembly 116 is spaced apart from the first air-foil assembly 112. The second air-foil assembly 116 is coupled to the air-foil support structure 108 in such a way that the second air-foil assembly 116 is pitched relative to the tangential line 114. Preferably (and not limited thereto) during normal basic operation, the second air-foil assembly 116 is fixedly pitched relative to the air-foil support structure 108 (as the air-foil support structure 108 is rotated by the elongated rotatable shaft assembly 102). For instance, the second air-foil assembly 116 may be called a trailing air-foil assembly (that is, the second air-foil assembly 116 trails behind the first air-foil assembly 112 as the first air-foil assembly 112 leads into the rotation direction 106). The second air-foil assembly 116 travels along the rotation direction 106.

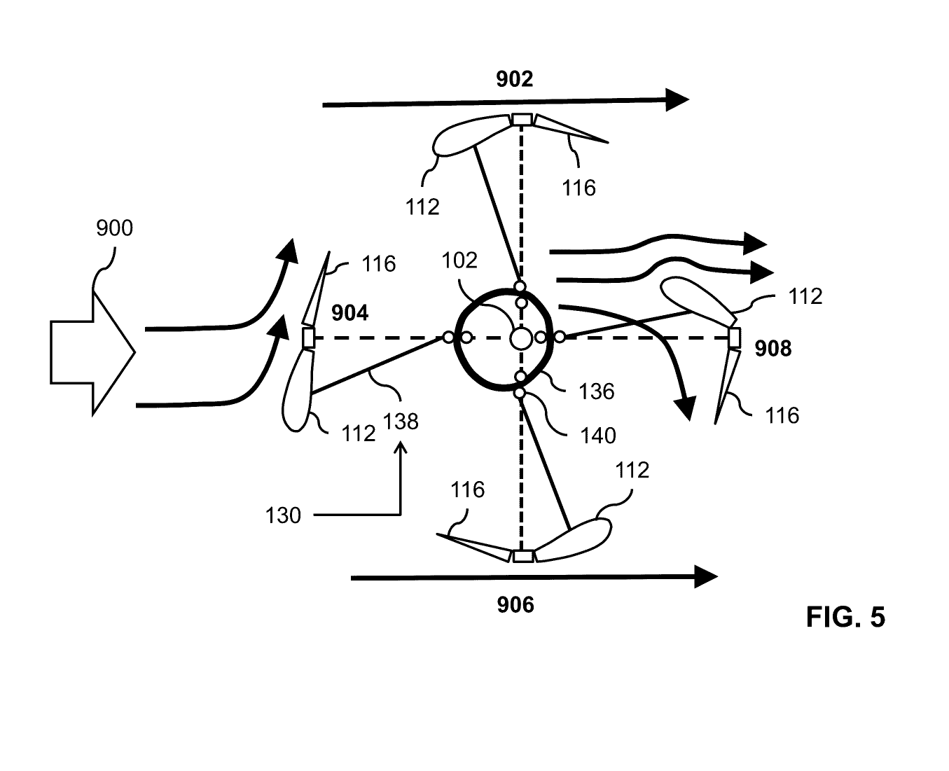

It will be appreciated that the first air-foil assembly 112 is configured to provide drag-resistance reduction to the second air-foil assembly 116 as the elongated rotatable shaft assembly 102 is made to rotate (during normal operation as described in connection with FIG. 5).

In accordance with a specific embodiment (option), the wind turbine 100 is adapted in such a way that the second air-foil assembly 116 is positioned to trail behind the first air-foil assembly 112 once the first air-foil assembly 112 and the second air-foil assembly 116 are operatively coupled (mounted) to the air-foil support structure 108 and the elongated rotatable shaft assembly 102 is made to rotate.

In accordance with a specific embodiment (option), the wind turbine 100 is adapted in such a way that the second air-foil assembly 116 is fixedly pitched relative to the tangential line 114 extending tangentially from the curved path 110, and the amount of pitch of the second air-foil assembly 116 is constant regardless of the position of the second air-foil assembly 116 along the curved path 110.

For illustration purposes and ease of description of the operation of the wind turbine 100, the wind travels along a wind direction 900 from the left side to the right side of FIG. 1. Interaction of the wind turbine 100 with the wind (wind flow) travelling along the wind direction 900 is explained in connection with FIG. 5 (and other FIGS. as well).

As depicted in the embodiment (option) of FIG. 1, there are four instances of the first air-foil assembly 112 and four instances of the second air-foil assembly 116 each operatively coupled to the air-foil support structure 108 at various positions along the curved path 110. Specifically, the instances of the first air-foil assembly 112 and the second air-foil assembly 116 are coupled to the air-foil support structure 108 at a first position 902 (also called position A), a second position 904 (also called position B), a third position 906 (also called position C), and a fourth position 908 (also called position D). Preferably, the first position 902, the second position 904, the third position 906 and the fourth position 908 are spatially positioned in a spaced-apart arrangement at 90 degree positions from each other along the curved path 110.

An instance of the first air-foil assembly 112 and an instance of the second air-foil assembly 116 (a pairing of the first air-foil assembly 112 and the second air-foil assembly 116) is coupled to the air-foil support structure 108 at the first position 902. An instance of the first air-foil assembly 112 and an instance of the second air-foil assembly 116 is coupled to the air-foil support structure 108 at the second position 904. An instance of the first air-foil assembly 112 and an instance of the second air-foil assembly 116 is coupled to the air-foil support structure 108 at the third position 906. An instance of the first air-foil assembly 112 and an instance of the second air-foil assembly 116 is coupled to the air-foil support structure 108 at the fourth position 908.

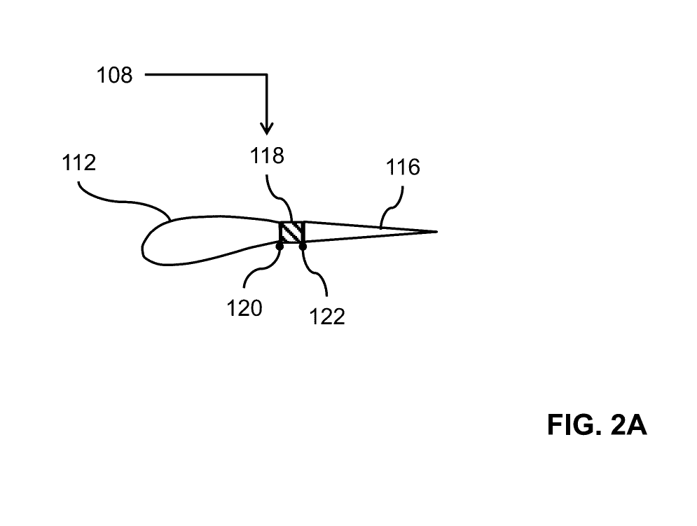

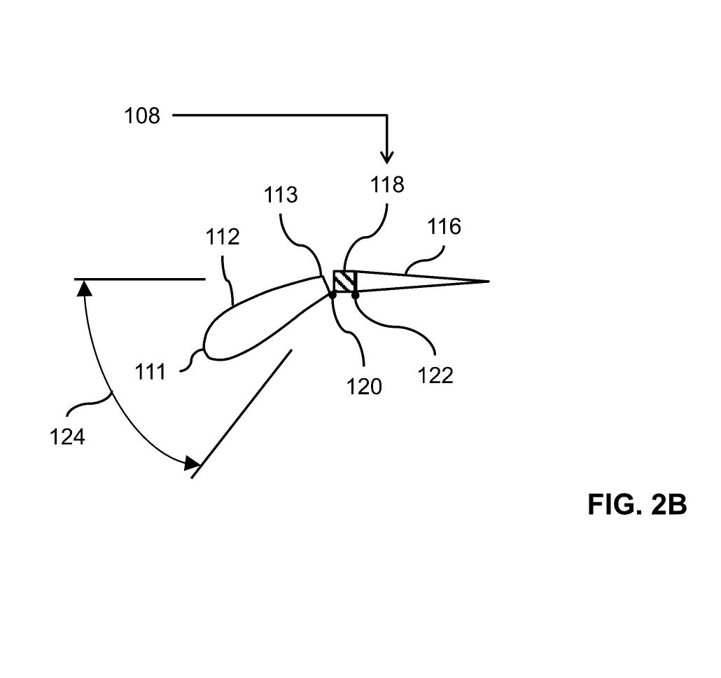

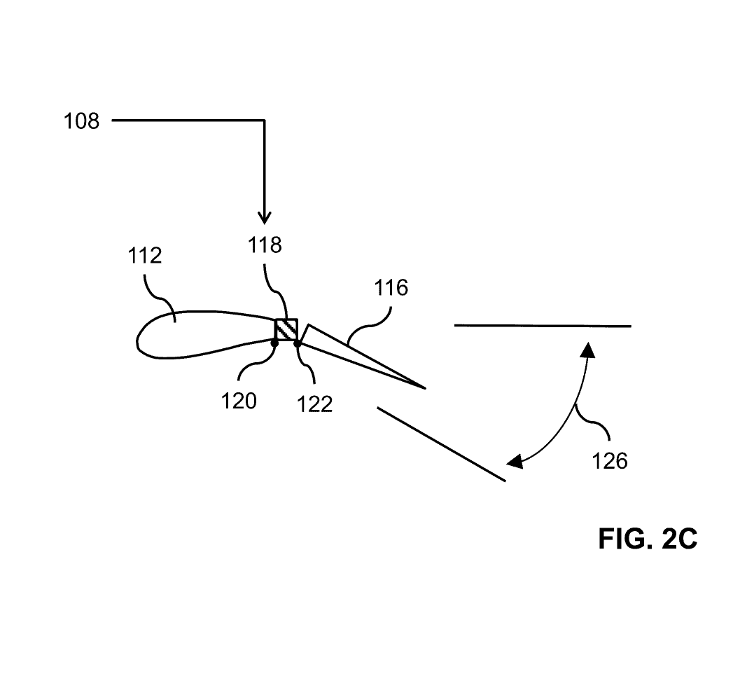

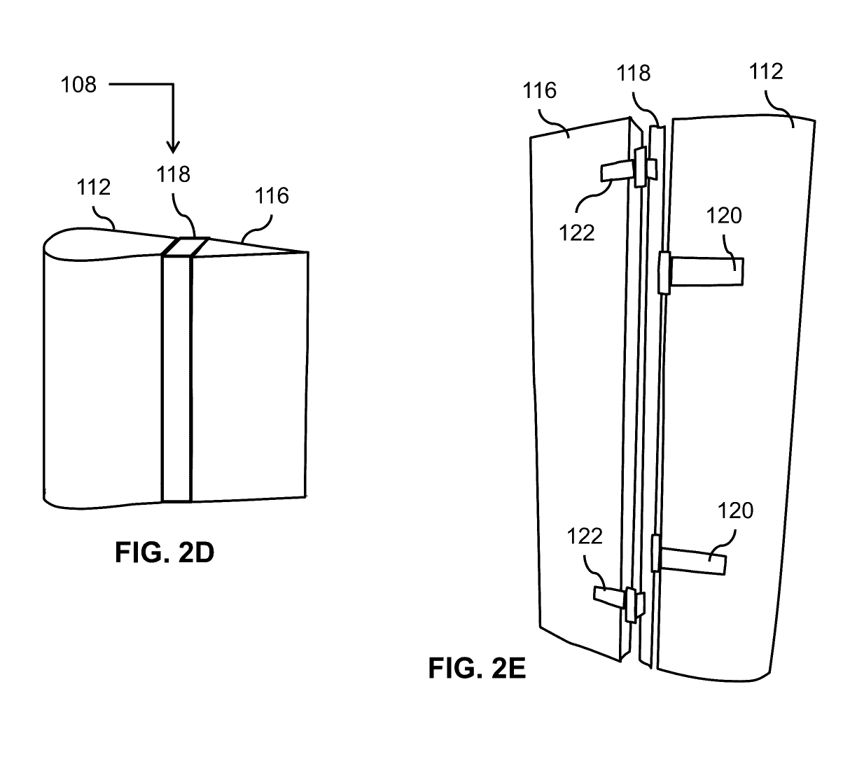

FIGS. 2A to 2E depict schematic views of embodiments of the first air-foil assembly 112 and of the second air-foil assembly 116 of the wind turbine 100 of FIG. 1. FIGS. 2A, 2B and 2C depict top views. FIGS. 2D and 2E depict perspective views.

In accordance with the embodiment depicted in FIG. 2A, the air-foil support structure 108 includes a longitudinally-extending tubular frame 118. An instance of the longitudinally-extending tubular frame 118 is to be positioned at the first position 902, the second position 904, the third position 906 and the fourth position 908 (depicted in FIG. 1). The air-foil support structure 108 includes the longitudinally-extending tubular frame 118 coupled to the first air-foil assembly 112 and the second air-foil assembly 116. As depicted, the first air-foil assembly 112 may be pivotally attached to the longitudinally-extending tubular frame 118. The second air-foil assembly 116 may be pivotally attached to the longitudinally-extending tubular frame 118. Specifically, a first hinge assembly 120 pivotally connects the first air-foil assembly 112 to the air-foil support structure 108. The second hinge assembly 122 pivotally connects the second air-foil assembly 116 to the air-foil support structure 108.

Referring to the embodiment depicted in FIG. 2B, in accordance with an embodiment, the second air-foil assembly 116 is configured to be front pivoting. In accordance with a preferred embodiment, the first air-foil assembly 112 is configured to be rear pivoting. The first air-foil assembly 112 has a leading edge 111 (a leading zone) and a trailing edge 113 (a trailing zone) that is spaced apart from the leading edge 111. The leading edge 111 of the first air-foil assembly 112 is oriented to lead into the direction of travel of the first air-foil assembly 112 (as shown travelling counter clockwise in FIG. 1). The trailing edge 113 trails behind the leading edge 111 as the first air-foil assembly 112 is made to travel along the curved path 110 (as depicted in FIG. 1). The trailing edge 113 (the trailing portion) of the first air-foil assembly 112 is configured to be pivotally connected to the air-foil support structure 108. The second air-foil assembly 116 has a leading edge and a trailing edge that are similar to those of the first air-foil assembly 112.

In accordance with the embodiment depicted in FIG. 2B, the first air-foil assembly 112 is configured to pivot (rotate) along a first pivoting range 124. The pitch of the first air-foil assembly 112 is defined as the amount of pivot that the first air-foil assembly 112 rotates relative to the air-foil support structure 108 (during normal operation of the first air-foil assembly 112). The amount of pitch of the first air-foil assembly 112 depends on the position of the first air-foil assembly 112 along the curved path 110 (depicted in FIG. 1).

In accordance with the embodiment depicted in FIG. 2C, the second air-foil assembly 116 is configured to pivot (rotate) along a second pivoting range 126. The pitch of the second air-foil assembly 116 is defined as the amount of pivot that the second air-foil assembly 116 rotates relative to the air-foil support structure 108.

In accordance with an option, during normal operation of the second air-foil assembly 116, the second air-foil assembly 116 is not expected to pivot (change pitch). The second air-foil assembly 116 does not pivot and is held in a fixed relationship relative to the air-foil support structure 108 as elongated rotatable shaft assembly 102 is made to rotate. Once the pitch of the second air-foil assembly 116 is set to a fixed amount of pitch, the pitch of the second air-foil assembly 116 remains fixed (an unchanging pitch amount) as the second air-foil assembly 116 travels along the curved path 110 depicted in FIG. 1. It will be appreciated that the pitch of the second air-foil assembly 116 may be changed at any time (on the fly during operation of the wind turbine 100 if so desired) or the pitch of the second air-foil assembly 116 may be fixed (set) and never changes once set during operation of the wind turbine 100.

In accordance with another option, during normal operation of the second air-foil assembly 116, the second air-foil assembly 116 may pivot (change pitch on the fly) as may be required (to some extent) to optimize the performance of the wind turbine 100 (of FIG. 1), as may be required, during operation of the wind turbine 100. For this case, the pitch of the second air-foil assembly 116 may change as the second air-foil assembly 116 travels along the curved path 110 depicted in FIG. 1. The amount of pitch of the second air-foil assembly 116 may or may not depend on the spatial position of the second air-foil assembly 116 along the curved path 110 (as the second air-foil assembly 116 travels along the curved path 110). Preferably, the second air-foil assembly 116 is hinged (pivoted or moved) to permit adjustment of pitch (orientation) of the second air-foil assembly 116, and then once positioned just so, the second air-foil assembly 116 is spatially locked relative to the air-foil support structure 108 (such as the longitudinally-extending tubular frame 118) during normal operation of the wind turbine 100, and then the second air-foil assembly 116 does not pivot thereafter (until needed to do so, if required).

In accordance with the embodiment depicted in FIG. 2D, the first air-foil assembly 112 has a longitudinally-extending length with a cross section forming a wing section, with the tail of the wing section facing the longitudinally-extending tubular frame 118 of the air-foil support structure 108. The second air-foil assembly 116 has a longitudinally-extending length with a triangular cross section, and with the base of the triangular cross section facing the longitudinally-extending tubular frame 118 of the air-foil support structure 108. The longitudinally-extending tubular frame 118 is positioned between the first air-foil assembly 112 and the second air-foil assembly 116, and it will be appreciated that other configurations are possible.

In accordance with the embodiment depicted in FIG. 2E, the longitudinally-extending tubular frame 118 has a longitudinally-extending length.

FIGS. 3A to 3C depict schematic views of embodiments of the elongated rotatable shaft assembly 102 and of the air-foil support structure 108 of the wind turbine 100 of FIG. 1. FIGS. 3A and 3B depict perspective views. FIG. 3C depicts a top view.

In accordance with the embodiment depicted in FIG. 3A, instances of the longitudinally-extending tubular frame 118 extends along a longitudinal length of the elongated rotatable shaft assembly 102 and are positioned on opposite sides of the elongated rotatable shaft assembly 102. The air-foil support structure 108 includes support arms 128 that are fixedly attached to the elongated rotatable shaft assembly 102, and extend radially from the elongated rotatable shaft assembly 102. The support arms 128 fixedly connect the longitudinally-extending tubular frame 118 to the elongated rotatable shaft assembly 102. The longitudinally-extending tubular frame 118 is spaced apart from the elongated rotatable shaft assembly 102. The instances of the longitudinally-extending tubular frames 118 are spaced apart from each other. The air-foil support structure 108 also includes bearing supports 105 configured to rotatably support the elongated rotatable shaft assembly 102, etc.

In accordance with the embodiment depicted in FIG. 3B, the elongated rotatable shaft assembly 102 is operatively connected (directly or indirectly) to the shaft (rod) of the electrical generator 103. Instances of the longitudinally-extending tubular frame 118 are positioned at the first position 902, the second position 904, the third position 906 and the fourth position 908 (depicted in FIG. 1).

In accordance with the embodiment depicted in FIG. 3C, during normal operation, the first air-foil assembly 112 does not exceed the outer diameter of the curved path 110 of the wind turbine 100 (within a permitted tolerance zone on either side of the curved path 110). The first air-foil assembly 112 remains within the outer reaches of the curved path 110 of the wind turbine 100. The air-foil support structure 108 includes a combination of the longitudinally-extending tubular frame 118 and the support arms 128 configured to support the spatial position of the first air-foil assembly 112 and the second air-foil assembly 116; this support is done as the elongated rotatable shaft assembly 102 is made to be rotated by way of interaction of the wind with the first air-foil assembly 112 and the second air-foil assembly 116.

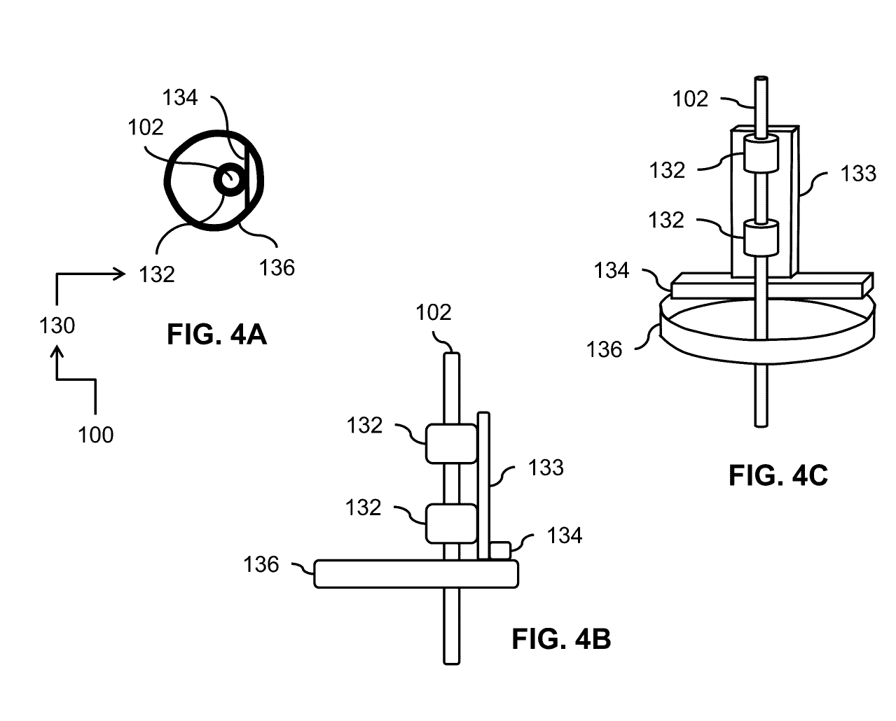

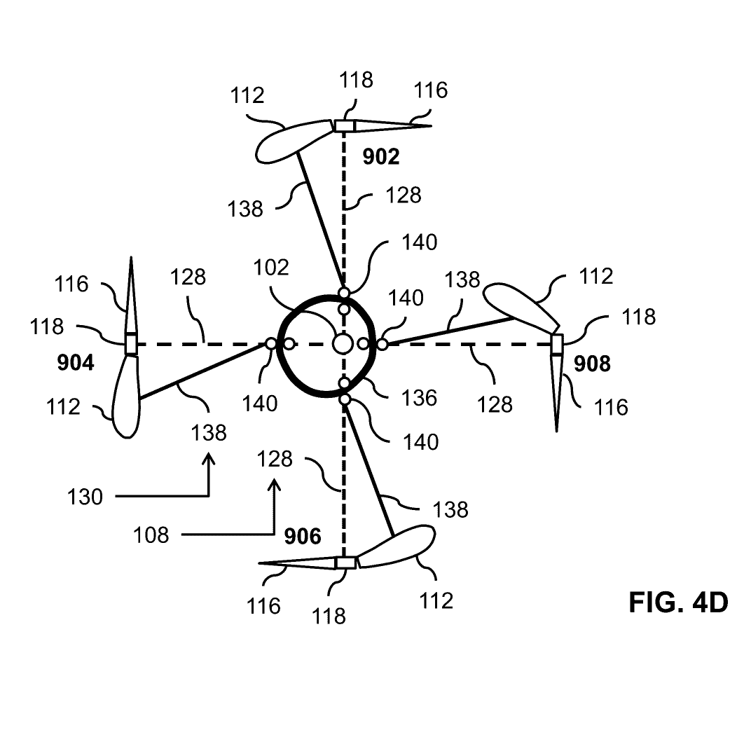

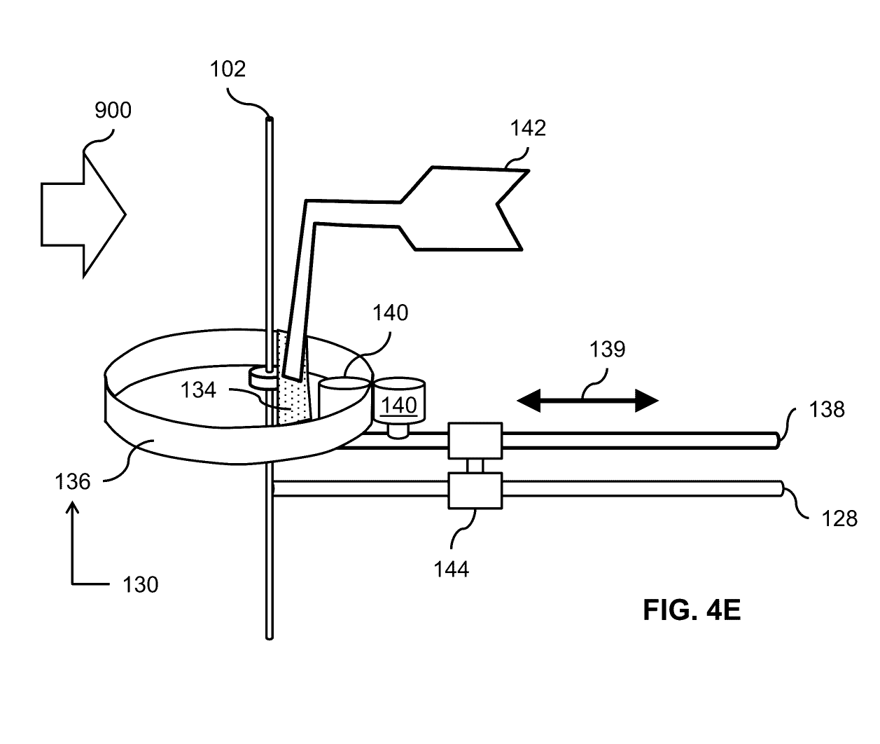

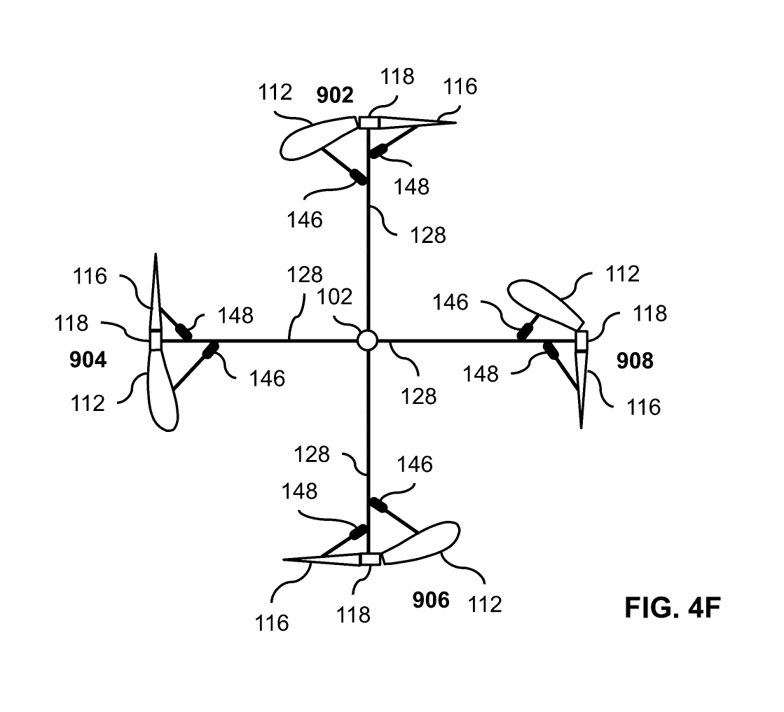

FIGS. 4A to 4G depict schematic views of embodiments of an air-foil pitch control mechanism 130 of the wind turbine 100 of FIG. 1. FIGS. 4A, 4D and 4F depict top views. FIG. 4B depicts a side view. FIGS. 4C and 4E depict perspective views.

In accordance with the embodiment depicted in FIG. 4A, the wind turbine 100 further includes the air-foil pitch control mechanism 130. The air-foil pitch control mechanism 130 is configured to control the operation of the first air-foil assembly 112 (depicted in FIG. 1).

The air-foil pitch control mechanism 130 includes a cam bearing 132 configured to be fixedly connected to the elongated rotatable shaft assembly 102. A cam support 134 is affixed to the cam bearing 132 and extends radially from the cam bearing 132. A cam assembly 136 is affixed to the cam support 134 in such a way that the elongated rotatable shaft assembly 102 is positioned within the footprint of the cam assembly 136. The cam assembly 136 is mounted in an off-axis position relative to the elongated rotatable shaft assembly 102 (so that the pitch of the first air-foil assembly 112 may be changed in response to the interaction between the roller assembly 140 and the movable control arm 138 (as depicted in FIG. 4D). In accordance with the embodiment depicted in FIGS. 4B and 4C, two instances of the cam bearing 132 are operatively attached to the elongated rotatable shaft assembly 102 and are spaced apart from each other. A cam bearing support 133 extends from the cam support 134, and the cam bearing support 133 supports the position of the cam bearing 132 relative to the elongated rotatable shaft assembly 102.

In accordance with the embodiment depicted in FIG. 4D, the cam assembly 136 is mounted in an off-axis position relative to the elongated rotatable shaft assembly 102, and in this manner the pitch of the first air-foil assembly 112 may be changed in response to the interaction between the roller assembly 140 and the movable control arm 138 (as depicted in FIG. 4D). The air-foil pitch control mechanism 130 further includes a movable control arm 138 and a roller assembly 140. The movable control arm 138 is operatively connected (pivotally connected) to the first air-foil assembly 112. The movable control arm 138 extends towards the roller assembly 140. The roller assembly 140 is configured to interact with the cam assembly 136. The cam assembly 136 provides (forms) a control shape configured to interact with the roller assembly 140 in such a way that the movable control arm 138 moves and changes the pitch of the first air-foil assembly 112 depending on the position of the first air-foil assembly 112 relative to the air-foil support structure 108 as the first air-foil assembly 112 is made to travel along the curved path 110 (depicted in FIG. 1).

The position or orientation of the cam assembly 136 depends on the direction in which the wind blows (as depicted in FIG. 4E).

At the first position 902, the movable control arm 138 is moved (by the interaction of the cam assembly 136 with the roller assembly 140) so that the pitch of the first air-foil assembly 112 is such that the first air-foil assembly 112 is aligned slightly inward toward the elongated rotatable shaft assembly 102.

At the second position 904, the movable control arm 138 is moved (by the interaction of the cam assembly 136 with the roller assembly 140) so that the pitch of the first air-foil assembly 112 is such that the first air-foil assembly 112 is aligned away from the elongated rotatable shaft assembly 102.

At the third position 906, the movable control arm 138 is moved (by the interaction of the cam assembly 136 with the roller assembly 140) so that the pitch of the first air-foil assembly 112 is such that the first air-foil assembly 112 is aligned slightly inward toward the elongated rotatable shaft assembly 102.

At the fourth position 908, the movable control arm 138 is moved (by the interaction of the cam assembly 136 with the roller assembly 140) so that the pitch of the first air-foil assembly 112 is such that the first air-foil assembly 112 is aligned toward the elongated rotatable shaft assembly 102.

In accordance with the embodiment depicted in FIG. 4E, the position or orientation of the cam assembly 136 depends on the direction in which the wind blows. The wind direction 900 shows wind movement from the left side to the right side of FIG. 4E.

The air-foil pitch control mechanism 130 further includes a wind vane 142 fixedly attached to and extending from the cam support 134. The wind vane 142 trails the wind direction 900. The wind vane 142 rotates the cam assembly 136 into a position to mechanically adjust the first air-foil assembly 112. The first air-foil assembly 112 is also called a drag reduction foil.

For the case where the wind blows on the wind vane 142, the wind urges the wind vane 142 to position (rotate) the cam assembly 136 to a predetermined orientation (relative to the air-foil support structure 108 (as depicted in FIG. 4D). The cam assembly 136 remains in a relatively stationary position for the case where the wind keeps blowing along the same direction (as indicated by wind direction 900, for instance).

As the first air-foil assembly 112 is made to rotate along the curved path 110 (as depicted in FIG. 1), the roller assembly 140 (that are mounted to the end section of the movable control arm 138) rotates along the surface of the cam assembly 136, and in response to the rolling action of the roller assembly 140, the movable control arm 138 is made to move (reciprocate) along a direction extending radially from the elongated rotatable shaft assembly 102. The amount of reciprocating movement of the movable control arm 138 depends on the position of the roller assembly 140 along the cam assembly 136 as the first air-foil assembly 112 rotates along the curved path 110 (as depicted in FIG. 1).

The cam assembly 136 is mounted in an off-axis position relative to the elongated rotatable shaft assembly 102.

The movable control arm 138 slides through a bushing assembly 144. The bushing assembly 144 is slidably mounted to the movable control arm 138, and is fixedly mounted to the support arms 128. The movement of the movable control arm 138 is along a control direction 139.

Referring to the embodiment depicted in FIG. 4F, the air-foil pitch control mechanism 130 includes a first servo assembly 146 coupled to the first air-foil assembly 112. The first servo assembly 146 is configured to adjust the pitch of the first air-foil assembly 112. A second servo assembly 148 is coupled to the second air-foil assembly 116, and is configured to adjust the pitch of the second air-foil assembly 116. For this case, the second servo assembly 148 is installed to the second air-foil assembly 116 to make slight adjustments on the fly to the pitch of the second air-foil assembly 116 (this may be done to fine tune the operation of the wind turbine 100 to suit the environmental conditions, etc.).

Referring to an option to the embodiment depicted in FIG. 4F, the air-foil pitch control mechanism 130 includes the first servo assembly 146 for the first air-foil assembly 112, and a servo assembly is not installed to the second air-foil assembly 116 (for this case).

FIG. 5 depicts a schematic view of an embodiment of the wind turbine 100 of FIG. 1 in operation. FIG. 5 depicts a top view.

In accordance with the embodiment depicted in FIG. 5, the first air-foil assembly 112 is configured to provide drag-resistance reduction to the second air-foil assembly 116 as the elongated rotatable shaft assembly 102 is made to rotate (during normal operation). The first air-foil assembly 112 is configured to pivot within a range during normal operation of wind turbine 100.

In accordance with a preferred embodiment, the second air-foil assembly 116 is formed as a wedge-shaped configuration for improved operation.

The air-foil pitch control mechanism 130 is configured to manipulate air flow onto the first air-foil assembly 112 in such a way that drag is reduced (at least in part) for the second air-foil assembly 116 at the fourth position 908, as well as other less critical positions.

In accordance with a preferred embodiment, the first air-foil assembly 112 is configured to form the curved path 110 as a circular pattern while the wind turbine 100 operates. The first air-foil assembly 112 is configured to redirect wind to reduce drag, and the first air-foil assembly 112 exposes more surface area when needed to harness more power. In a preferred embodiment, the pitch of the first air-foil assembly 112 is controlled by the cam assembly 136. The cam assembly 136 may be called a degreed camshaft). In accordance with a preferred embodiment, the outer side of the first air-foil assembly 112 is configured to generate lift, and the inner side of the first air-foil assembly 112 is configured (cambered) to reduce drag. The first air-foil assembly 112 pivots from the back end of the first air-foil assembly 112 with no overhang. The first air-foil assembly 112 redirects air onto the second air-foil assembly 116, and the second air-foil assembly 116 is configured to rotate the elongated rotatable shaft assembly 102 in response to the wind striking the second air-foil assembly 116. The first air-foil assembly 112 travels along a circular orbit (path) and the first air-foil assembly 112 does not overhang. The first air-foil assembly 112 pivots at the outer most edge of the curved path 110 (as depicted in FIG. 1). The first air-foil assembly 112 is pitch manipulated during rotation of the elongated rotatable shaft assembly 102 (to reduce drag on the second air-foil assembly 116), and the second air-foil assembly 116 is to propel (rotate) the elongated rotatable shaft assembly 102 (in response to the second air-foil assembly 116 interacting with the wind or wind flow). An advantage of the first air-foil assembly 112 placed in the leading edge ahead of the second air-foil assembly 116 in the wind turbine 100 is to change a relatively higher drag position (the fourth position 908) into a power producing position. The first air-foil assembly 112 is mounted to a leading edge of the wind turbine 100, and the first air-foil assembly 112 is configured to redirect fluid onto the second air-foil assembly 116, or around the second air-foil assembly 116 depending on the position of the second air-foil assembly 116 around the elongated rotatable shaft assembly 102. Preferably, the first air-foil assembly 112 does not extend (or hardly extends) past the outer most point of the perimeter of the wind turbine 100.

In the upwind position (the second position 904), the first air-foil assembly 112 and the second air-foil assembly 116 add more surface area to extract wind energy.

In the downwind position (the fourth position 908), the first air-foil assembly 112 is configured to redirect fluid onto the second air-foil assembly 116 to reduce (preferably to eliminate) drag (that is, resistance to movement), and to extract relatively more power (that is, rotational movement) in response to wind flowing over the second air-foil assembly 116.

On the opposite sides (such as, the first position 902 and the third position 906), the first air-foil assembly 112 and the second air-foil assembly 116 are aligned with the wind direction or wind flow (and for this case, the alignment is to maintain an aerodynamic position to reduce wind resistance).

The second air-foil assembly 116 is configured to rotate the elongated rotatable shaft assembly 102 (in response to wind striking the second air-foil assembly 116), and the first air-foil assembly 112 is configured to reduce drag of the second air-foil assembly 116.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It will be appreciated that the first air-foil assembly 112 and the air-foil pitch control mechanism 130 may be provided as a retrofit kit, and the retrofit kit is deployed for retrofitting existing wind turbines (if so desired). The retrofit kit includes the first air-foil assembly 112 and the air-foil pitch control mechanism 130 for the first air-foil assembly 112. A retrofit kit is for a wind turbine 100 that has an air-foil support structure 108 configured to travel along a curved path 110. The wind turbine 100 also has a second air-foil assembly 116 configured to be coupled to the air-foil support structure 108 in such a way that the second air-foil assembly 116 is pitched. The retrofit kit includes a first air-foil assembly 112. The first air-foil assembly 112 includes a mounting assembly. The mounting assembly is configured to couple the first air-foil assembly 112 to the air-foil support structure 108. This is done in such a way that the first air-foil assembly 112 is pitched once mounted just so to the air-foil support structure 108, and the first air-foil assembly 112 is spaced apart from second air-foil assembly 116.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. A wind turbine, comprising:
an air-foil support structure;
a first air-foil assembly being configured to be coupled to the air-foil support structure in such a way that the first air-foil assembly is pitched; and
a second air-foil assembly being configured to be coupled to the air-foil support structure, and the second air-foil assembly being spaced apart from the first air-foil assembly in such a way that the second air-foil assembly is pitched.

2. The wind turbine of claim 1, wherein:
the second air-foil assembly is to rotate the air-foil support structure in response to the second air-foil assembly interacting with wind flow; and
the first air-foil assembly is configured to provide drag-resistance reduction to the second air-foil assembly as the air-foil support structure is made to rotate by the second air-foil assembly.

3. A wind turbine, comprising:
an elongated rotatable shaft assembly having a longitudinal axis extending therethrough, and the elongated rotatable shaft assembly being configured to rotate along the longitudinal axis through a rotation direction;
an air-foil support structure being fixedly attached to the elongated rotatable shaft assembly, and the air-foil support structure extending radially from the elongated rotatable shaft assembly;
a first air-foil assembly being configured to be coupled to the air-foil support structure in such a way that the first air-foil assembly travels along a curved path once the elongated rotatable shaft assembly is rotated along the longitudinal axis, and the first air-foil assembly is variably pitched relative to a tangential line extending tangentially from the curved path, and the amount of pitch of the first air-foil assembly depends on the position of the first air-foil assembly along the curved path; and
a second air-foil assembly being configured to be coupled to the air-foil support structure, and the second air-foil assembly being spaced apart from the first air-foil assembly in such a way that the second air-foil assembly is pitched relative to the tangential line.

4. The wind turbine of claim 3, wherein:
the second air-foil assembly is positioned to trail behind the first air-foil assembly once: (A) the first air-foil assembly and the second air-foil assembly are operatively coupled to the air-foil support structure, and (B) the elongated rotatable shaft assembly is made to rotate by the second air-foil assembly.

5. The wind turbine of claim 3, wherein:
the second air-foil assembly is fixedly pitched relative to the tangential line extending tangentially from the curved path; and
the amount of pitch of the second air-foil assembly is constant regardless of the position of the second air-foil assembly along the curved path.

6. The wind turbine of claim 3, further comprising:
an electrical generator; and
wherein the elongated rotatable shaft assembly is configured to operatively turn the electrical generator.

7. The wind turbine of claim 3, wherein:
the first air-foil assembly is configured to provide drag-resistance reduction to the second air-foil assembly as the elongated rotatable shaft assembly is made to rotate; and
the second air-foil assembly is to rotate the elongated rotatable shaft assembly in response to the second air-foil assembly interacting with wind flow.

8. The wind turbine of claim 3, wherein:
instances of the first air-foil assembly and instances of the second air-foil assembly are each operatively coupled to the air-foil support structure at positions along the curved path.

9. The wind turbine of claim 3, wherein:
the air-foil support structure includes:
a longitudinally-extending tubular frame being coupled to the first air-foil assembly and the second air-foil assembly; and
wherein the first air-foil assembly is pivotally attached to the longitudinally-extending tubular frame.

10. The wind turbine of claim 9, wherein:
the second air-foil assembly is pivotally attached to the longitudinally-extending tubular frame.

11. The wind turbine of claim 3, wherein:
the second air-foil assembly is held in a fixed relationship relative to the air-foil support structure as the elongated rotatable shaft assembly is made to rotate.

12. The wind turbine of claim 3, wherein:
the first air-foil assembly has a longitudinally-extending length with a cross section forming a wing section, with a tail of the wing section facing a longitudinally-extending tubular frame of the air-foil support structure.

13. The wind turbine of claim 3, wherein:
the second air-foil assembly has a longitudinally-extending length with a triangular cross section, and with a base of the triangular cross section facing a longitudinally-extending tubular frame of the air-foil support structure.

14. The wind turbine of claim 3, wherein:
the air-foil support structure includes:
a longitudinally-extending tubular frame being positioned between the first air-foil assembly and the second air-foil assembly.

15. The wind turbine of claim 3, wherein:
the air-foil support structure includes:
longitudinally-extending tubular frames extending along a longitudinal length of the elongated rotatable shaft assembly, and the longitudinally-extending tubular frames being positioned on opposite sides of the elongated rotatable shaft assembly;
support arms being fixedly attached to the elongated rotatable shaft assembly, and the support arms extending radially from the elongated rotatable shaft assembly, and the support arms fixedly connecting the longitudinally-extending tubular frames to the elongated rotatable shaft assembly; and
wherein the longitudinally-extending tubular frames are spaced apart from the elongated rotatable shaft assembly, and
wherein the longitudinally-extending tubular frames are spaced apart from each other.

16. The wind turbine of claim 3, wherein:
the first air-foil assembly remains within the curved path of the wind turbine.

17. The wind turbine of claim 3, further comprising:
an air-foil pitch control mechanism being configured to control operation of the first air-foil assembly.

18. The wind turbine of claim 3, wherein:
an air-foil pitch control mechanism being configured to control operation of the first air-foil assembly,
the air-foil pitch control mechanism including any one of a cam system and a servo system;
the cam system including:
a cam bearing being configured to be fixedly connected to the elongated rotatable shaft assembly;
a cam support being affixed to the cam bearing and extending radially from the cam bearing;
a cam assembly being affixed to the cam support in such a way that the elongated rotatable shaft assembly is positioned within a footprint of the cam assembly, and the cam assembly being mounted in an off-axis position relative to the elongated rotatable shaft assembly so that the pitch of the first air-foil assembly is changeable;
a movable control arm being operatively connected to the first air-foil assembly; and
a roller assembly being configured to interact with the cam assembly, and the movable control arm extends towards the roller assembly; and
the cam assembly being configured to provide a control shape configured to interact with the roller assembly in such a way that the movable control arm moves and changes the pitch of the first air-foil assembly depending on the position of the first air-foil assembly relative to the air-foil support structure as the first air-foil assembly is made to travel along the curved path; and
the servo system including any one of:
a first servo assembly coupled to the first air-foil assembly, and the first servo assembly being configured to adjust the pitch of the first air-foil assembly; and
a second servo assembly being coupled to the second air-foil assembly, and the second servo assembly being configured to adjust the pitch of the second air-foil assembly.

19. The wind turbine of claim 3, wherein:
the first air-foil assembly includes:
a leading edge oriented to lead into a direction of travel of the first air-foil assembly; and
a trailing edge spaced apart from the leading edge, the trailing edge trails behind the leading edge as the first air-foil assembly is made to travel, and the trailing edge is configured to be pivotally connected to the air-foil support structure.

20. A retrofit kit for a wind turbine having an air-foil support structure being configured to travel along a curved path, and the wind turbine also having a second air-foil assembly being configured to be coupled to the air-foil support structure in such a way that the second air-foil assembly is pitched, and the retrofit kit comprising:
a first air-foil assembly including:
a mounting assembly being configured to couple the first air-foil assembly to the air-foil support structure in such a way that the first air-foil assembly is pitched once mounted just so to the air-foil support structure, and the first air-foil assembly is spaced apart from second air-foil assembly.
